(19) United States
(12) Patent Application Publication
(10) Pub. No.: US 2016/0249357 A1
(43) Pub. Date: Aug. 25, 2016

(54) SOFT ACCESS POINT MASTER MODE USING DUAL WIDEBAND CHANNELS

(71) Applicant: QUALCOMM Incorporated, San Diego, CA (US)

(72) Inventors: Michael Green, Needham, MA (US); Youhan Kim, Fremont, CA (US)

(21) Appl. No.: 14/626,638

(22) Filed: Feb. 19, 2015

(51) Int. Cl. H04W 72/04; H04W 76/02; H04W 24/08

(52) U.S. Cl. CPC H04W 72/0453; H04W 24/08; H04W 76/025; H04W 88/08

(57) ABSTRACT

Methods, systems, and devices are described for wireless communication at an AP. A station (STA) serving as a soft access point (SAP) in master mode may be configured to support communication over two radar channels (e.g., a primary and secondary channel) simultaneously. The STA may detect radar on the primary channel and move the primary channel to the secondary channel; meanwhile, the secondary channel may be moved to a channel in a non-radar subband. In some cases, the STA may establish a primary channel in a non-radar subband and then advertise a single bandwidth capacity. the STA may then perform a channel availability check (CAC) on a radar subband. If the CAC is successful, the STA may establish a secondary channel on the radar subband (or move the primary channel to the radar subband) and advertise a dual bandwidth capacity.

### BACKGROUND

1. Field of Disclosure

The following relates generally to wireless communication, for example soft access point (AP) master mode using dual wideband channels.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN) may include an AP that may communicate with one or more stations (STAs) or mobile devices. The AP may be coupled to a network, such as the Internet, and may enable a mobile device to communicate via the network (or communicate with other devices coupled to the access point in a service set, e.g., a basic service set (BSS) or extended service set (ESS)). A wireless device may communicate with a network device bi-directionally. For example, in a WLAN, a STA may communicate with an associated AP via downlink (DL) and UL. From the STA's perspective, the DL (or forward link) may refer to the communication link from the AP to the station, and the uplink (UL) (or reverse link) may refer to the communication link from the station to the AP. In some cases, a STA may provide connection services to other STAs as a soft AP.

A STA serving as a soft AP in master mode may be configured to communicate with another wireless communication device over two channels simultaneously. In some cases, one or both of the channels may be allocated for special purposes, such as radar applications. Accordingly, there may be instances in which both the STA and a radar application are using the same channel. An AP or a soft AP may vacate a channel upon detection of radar, but this may result in a suboptimal channel arrangement. That is, moving a primary channel from a radar subband may cause the primary channel to end up in a more congested frequency band than a secondary channel.

### SUMMARY

Systems, methods, and apparatuses for soft AP master mode using dual wideband channels are described. A station (STA) serving as a soft access point (SAP) in master mode may be configured to support communication over two radar channels (e.g., a primary and secondary channel) simultaneously. The STA may detect radar on the primary channel and move the primary channel to the secondary channel; meanwhile, the secondary channel may be moved to a channel in a non-radar subband. In some cases, the STA may establish a primary channel in a non-radar subband and then advertise a single bandwidth capacity. the STA may then perform a channel availability check (CAC) on a radar subband. If the CAC is successful, the STA may establish a secondary channel on the radar subband (or move the primary channel to the radar subband) and advertise a dual bandwidth capacity.

A method of wireless communication is described. The method may include establishing a primary channel in a first radar subband and a secondary channel in a second radar subband, detecting a radar signal in the first radar subband, moving the secondary channel to a non-radar subband based at least in part on detecting the radar signal, and moving the primary channel to the second radar subband based at least in part on detecting the radar signal and moving the secondary channel.

An apparatus for wireless communication is described. The apparatus may include a channel establishment component for establishing a primary channel in a first radar subband and a secondary channel in a second radar subband, a radar detector for detecting a radar signal in the first radar subband, a secondary radio controller for moving the secondary channel to a non-radar subband based at least in part on detecting the radar signal, and a primary radio controller for moving the primary channel to the second radar subband based at least in part on detecting the radar signal and moving the secondary channel.

A further apparatus for wireless communication is described. The apparatus may include a processor, memory in electronic communication with the processor, and instructions stored in the memory and operable, when executed by the processor, to cause the apparatus to establish a primary channel in a first radar subband and a secondary channel in a second radar subband, detect a radar signal in the first radar subband, move the secondary channel to a non-radar subband based at least in part on detecting the radar signal, and move the primary channel to the second radar subband based at least in part on detecting the radar signal and moving the secondary channel.

A non-transitory computer-readable medium storing code for wireless communication is described. The code may include instructions executable to establish a primary channel in a first radar subband and a secondary channel in a second radar subband, detect a radar signal in the first radar subband, move the secondary channel to a non-radar subband based at least in part on detecting the radar signal, and move the primary channel to the second radar subband based at least in part on detecting the radar signal and moving the secondary channel.

The method, apparatuses, or non-transitory computer-readable medium described herein may further include processes, features, means, or instructions for activating a soft AP feature, wherein establishing the primary and secondary channel is based at least in part on the soft AP feature. Additionally or alternatively, some examples may include processes, features, means, or instructions for advertising a dual bandwidth capacity based at least in part on the primary channel and the secondary channel.

The method, apparatuses, or non-transitory computer-readable medium described herein may further include processes, features, means, or instructions for performing a successful channel availability check (CAC) check on the first radar subband and the second radar subband, wherein establishing the primary and secondary channel is based at least in part on the successful CAC check. Additionally or alternatively, some examples may include processes, features, means, or instructions for performing a successful CAC check on a third radar subband based at least in part on moving the secondary channel to the non-radar subband, and moving the secondary channel to the third radar subband based at least in part on the successful CAC check on the third radar subband.

The method, apparatuses, or non-transitory computer-readable medium described herein may further include processes, features, means, or instructions for performing a successful CAC check on the first radar subband based at least in part on moving the primary channel to the second radar subband, and moving one of the primary channel or the secondary channel to the first radar subband based at least in part on the successful CAC check on the first radar subband. Additionally or alternatively, some examples may include processes, features, means, or instructions for performing the CAC check comprises using a first radio to communicate on one of the channels while concurrently performing the CAC check on the other of the channels.

A method of wireless communication is described. The method may include establishing a primary channel in a non-radar subband, advertising a single bandwidth capacity based at least in part on the primary channel, completing a successful CAC on a radar subband for a secondary channel after advertising the single bandwidth capacity, establishing the secondary channel in the radar subband based at least in part on the successful CAC, and advertising a dual bandwidth capacity based at least in part on the primary channel and the successful CAC.

An apparatus for wireless communication is described. The apparatus may include a channel establishment component for establishing a primary channel in a non-radar subband, an advertisement component for advertising a single bandwidth capacity based at least in part on the primary channel, a CAC component for completing a successful CAC on a radar subband for a secondary channel after advertising the single bandwidth capacity, a channel establishment component for establishing the secondary channel in the radar subband based at least in part on the successful CAC, and an advertisement component for advertising a dual bandwidth capacity based at least in part on the primary channel and the successful CAC.

An apparatus for wireless communication is described. The apparatus may include means for establishing a primary channel in a non-radar subband, means for advertising a single bandwidth capacity based at least in part on the primary channel, means for completing a successful CAC on a radar subband for a secondary channel after advertising the single bandwidth capacity means for establishing the secondary channel in the radar subband based at least in part on the successful CAC, and means for advertising a dual bandwidth capacity based at least in part on the primary channel and the successful CAC.

A non-transitory computer-readable medium storing code for wireless communication is described. The code may include instructions executable to establish a primary channel in a non-radar subband, advertise a single bandwidth capacity based at least in part on the primary channel, complete a successful CAC on a radar subband for a secondary channel after advertising the single bandwidth capacity, establish the secondary channel in the radar subband based at least in part on the successful CAC, and advertise a dual bandwidth capacity based at least in part on the primary channel and the successful CAC.

The method, apparatuses, or non-transitory computer-readable medium described herein may further include processes, features, means, or instructions for communicating over the primary channel using a first radio while concurrently performing the CAC on the radar subband using a second radio. Additionally or alternatively, in some examples the radar subband comprises a first radar subband, performing a second successful CAC on a second radar subband, and adding the second radar subband to a list available of radar subbands.

The method, apparatuses, or non-transitory computer-readable medium described herein may further include processes, features, means, or instructions for determining that the list contains a threshold number of subbands, and advertising the dual bandwidth capacity is based at least in part on the determination. Additionally or alternatively, some examples may include processes, features, means, or instructions for detecting a radar signal in the radar subband, and moving the secondary channel to the different subband based at least in part on detecting the radar signal in the radar subband.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) 100 (also known as a wireless fidelity (Wi-Fi) network) for soft access point (AP) master mode using dual wideband channels configured in accordance with various aspects of the present disclosure

FIG. 2 illustrates an example of a wireless communications subsystem that supports soft AP master mode using dual wideband channels in accordance with various aspects of the present disclosure;

FIG. 3 illustrates an example of a dynamic channel configuration that supports soft AP master mode using dual wideband channels in accordance with various aspects of the present disclosure;

FIG. 4A illustrates an example of a process flow that supports soft AP master mode using dual wideband channels in accordance with various aspects of the present disclosure;

FIG. 4B illustrates an example of a process flow that supports soft AP master mode using dual wideband channels in accordance with various aspects of the present disclosure;

FIG. 5 shows a block diagram of a wireless device that supports soft AP master mode using dual wideband channels in accordance with various aspects of the present disclosure;

FIG. 6 shows a block diagram of a wireless device that supports soft AP master mode using dual wideband channels in accordance with various aspects of the present disclosure;

FIG. 7 shows a block diagram of a wireless device that supports soft AP master mode using dual wideband channels in accordance with various aspects of the present disclosure;

FIG. 8 illustrates a block diagram of a system including a wireless device that supports soft AP master mode using dual wideband channels in accordance with various aspects of the present disclosure;

FIG. 9 illustrates a method for soft AP master mode using dual wideband channels in accordance with various aspects of the present disclosure;

FIG. 10 illustrates a method for soft AP master mode using dual wideband channels in accordance with various aspects of the present disclosure;

FIG. 11 illustrates a method for soft AP master mode using dual wideband channels in accordance with various aspects of the present disclosure;

FIG. 12 illustrates a method for soft AP master mode using dual wideband channels in accordance with various aspects of the present disclosure;

FIG. 13 illustrates a method for soft AP master mode using dual wideband channels in accordance with various aspects of the present disclosure; and

FIG. 14 illustrates a method for soft AP master mode using dual wideband channels in accordance with various aspects of the present disclosure.

### DETAILED DESCRIPTION

The described features generally relate to improved systems, methods, or apparatuses for soft AP master mode using dual wideband channels. In some wireless communication systems a station (STA) serving as a soft access point (SAP) in master mode may have dual radios such that the STA may communicate over two different channels at the same time. The STA may access and communicate over channels reserved for radar applications (e.g., airport radar, weather radar, etc.). Accordingly, the STA may be configured to detect radar signals present in a channel (e.g., the device may support dynamic frequency selection (DFS) and change frequencies accordingly). Before communicating over the new channel, the STA may wait a period of time (e.g., 60 seconds) to determine if the new channel is currently supporting radar applications (i.e., the STA may perform a channel availability check (CAC)). If the CAC is successful, the STA may advertise communication abilities associated with the new channel.

A STA in master mode may start basic service set (BSS) with SAP functions via a primary channel in a non-radar subband (e.g., unlicensed national information infrastructure 1 (UNII1)). The STA may select a secondary channel in a radar subband (e.g., UNII2) and commence CAC. After successful CAC, and if associated clients support dual bandwidth capacity, the STA may advertise the secondary channel. However, if associated clients do not support dual bandwidth capacity, the STA may refrain from advertising dual bandwidth capacity and instead continue to perform CACs on other radar subbands and use the results to generate a list of available channels. Once the list of available channels satisfies a threshold, the STA may advertise communication capacity and abilities associated with the secondary channel, regardless of the functionality of the associated clients.

The STA may establish BSS operation over primary and secondary channels that are both in a radar subband. In this instance, detection of a radar signal in the secondary channel may prompt the STA to switch the secondary channel to a non-radar channel to avoid interruption. Should the STA detect a radar signal in the primary channel, the STA may switch the primary channel to the secondary channel. In some cases, the STA may add a new secondary channel using any available non-radar subband.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

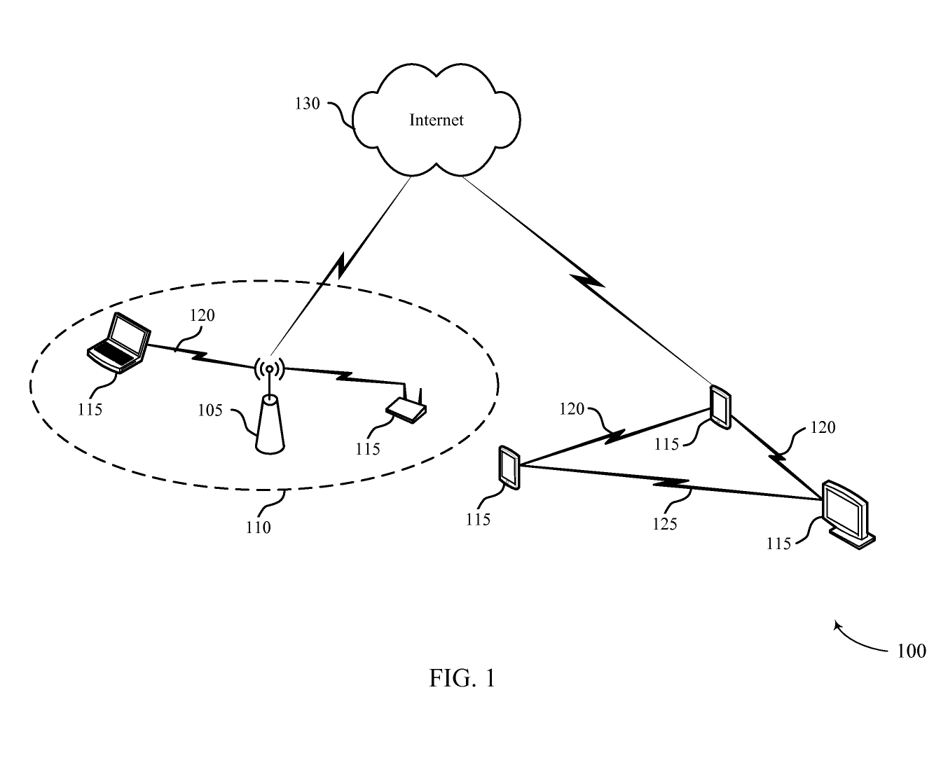

FIG. 1 illustrates a WLAN 100 (also known as a Wi-Fi network) configured in accordance with various aspects of the present disclosure. The WLAN 100 may include an access point AP 105 and multiple station (STAs) 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100.

A STA 115 may be configured to support communications between another STA 115 and an external network, such as a network 130 (e.g., the internet). For instance, a STA 115 may support a master mode that enables the STA 115 to serve as a soft AP (SAP); that is, the STA 115 may facilitate communications between a network 130 and STAs 115. the STAs 115 associated with an SAP may form a BSS which may be different from a BSS associated with an AP 105. For instance, some STAs 115 may be outside of coverage area 110 such that they are unable to access the network 130 via AP 105 or a direct connection. In such an instance, a STA 115 in master mode may create a network associated with a specified name and channels to provide network services (e.g., connecting an associated STA 115 to an external network 130). A STA 115 may be associated with a master mode STA 115 (i.e., be in managed mode or client mode) upon switching channels to match the master mode channel and providing acceptable credentials to the master mode STA 115.

The STA 115 serving as an SAP in master mode may communicate with a client STA 115 using a dual radio configuration. The use of two radios may enable the master mode STA 115 to exchange control and data over the air using two channels (e.g., the STA 115 may engage in 802.11ac 80+80 communications in which an 80 MHz band is used in conjunction with another 80 MHz band). The two channels may be called the primary and secondary channels and may convey information, such as control and data. In some cases, the primary channel may carry more control information than the secondary channel; accordingly, in some cases the primary channel may have a higher connection priority than the secondary channel.

The communication channels used by the STAs 115 may be within subbands allocated for radar applications, such as airport traffic control and weather services. Accordingly, channel conflict may arise when both the STAs 115 and a radar application attempt to facilitate communications using the same channel. In some cases, the radar application may be given priority over the STAs 115 (e.g., the radar application may continue to use the channel and the STAs 115 may drop the channel). In such cases, the master mode STA 115 may select a different channel on which to continue communications.

A master mode STA 115 may select a channel in a radar subband, or in a non-radar subband. If the new channel is in a radar subband, the STA 115 may perform a channel availability check (CAC) by listening for radar signals on the new channel for a period of time (e.g., 60 seconds). If the STA 115 detects a radar signal during the CAC, the CAC is said to have failed and the STA 115 may change channel frequencies again. If the STA 115 does not detect a radar signal, the CAC is said to have succeeded and the STA 115 may resume communications using the channel.

A master mode STA 115 may advertise the communication abilities associated with the BSS channels. For instance, upon establishment of a primary channel the STA 115 may advertise single bandwidth capacity. The STA 115 may begin communications over the primary channel while performing a CAC on a channel in a radar subband. Once the STA 115 has completed a successful CAC on the radar-subband channel, the STA 115 may establish the radar-subband channel as the secondary channel and commence secondary channel communications. Thus, the STA 115 may advertise dual bandwidth capacity based on the secondary channel.

The STAs 115 associated with the master mode STA 115 may not support dual bandwidth communications. In these instances, the master mode STA 115 may recognize or detect the capabilities of the associated STAs 115 and adjust communications accordingly. For example, the STA 115 in master mode may decide to perform CACs on a number of channels based on the capabilities of the associated STAs. The master mode STA 115 may generate a list of channels associated with successful CACs; thus, the STA 115 may refer to the available channel list to determine channel selections in the future.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (DS) (not shown) may be used to connect APs in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within WLAN 100.

Thus, a STA 115 may serve as a soft access point (SAP) in master mode and communicate with another STA 115 over two channels (e.g., a primary and secondary channel) simultaneously. The STA 115 in master mode may switch a communication channel based on the detection of a radar signal in the communication channel. In some cases, the master mode STA 115 may move the primary channel to the secondary channel and move the secondary channel to a new channel. The new channel may be based on a list of available channels associated with successful CACs.

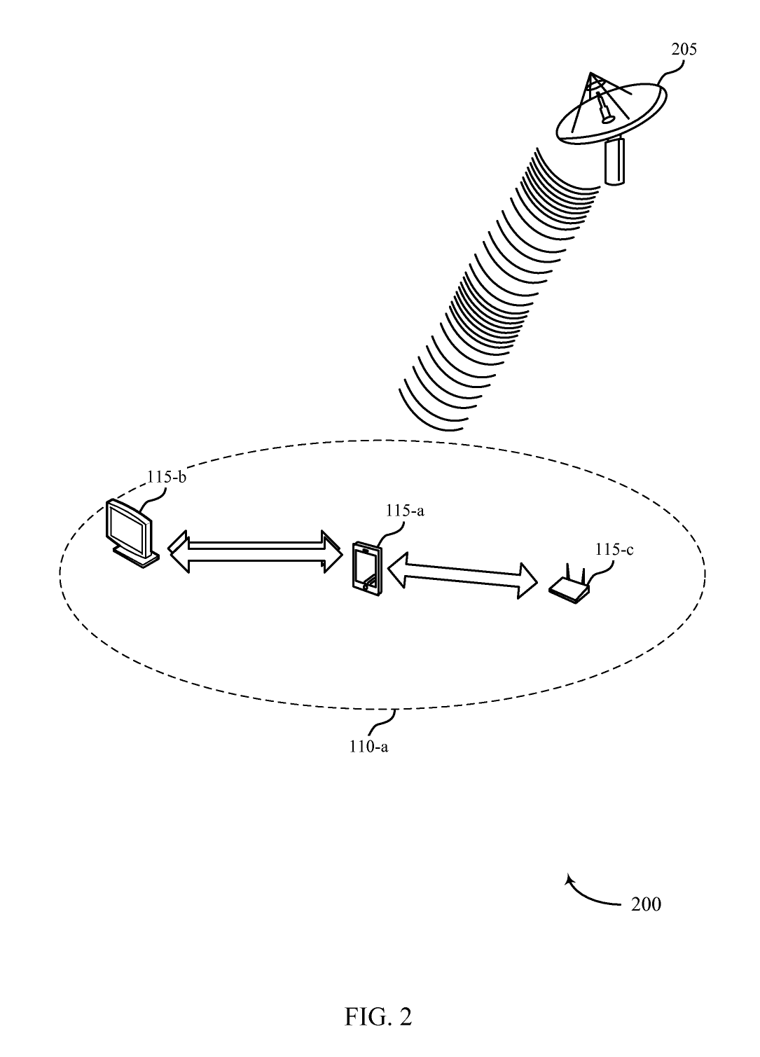

FIG. 2 illustrates an example of a wireless communications subsystem 200 for soft AP master mode using dual wideband channels in accordance with various aspects of the present disclosure. Wireless communications subsystem 200 may include a STA 115a, which may configured to serve as an SAP such as described herein with reference to FIG. 1. Wireless communications subsystem 200 may also include STA 115-b, and STA 115-c, which may be examples of STAs 115 also described herein with reference to FIG. 1. STA 115-a may provide connection services for the STAs 115 in a BSS. Wireless communication subsystem may also feature a radar 205, which may use frequencies within radar subbands, such as unlicensed national information infrastructure (UNII) channels (e.g., UNII2, UNII3, etc.) designated for radar applications. In some cases, radar 205 may have priority over STA 115-a for use of the frequency bandwidth radar 205 uses for operation.

STA 115-a may serve as a virtual connection between a network (not shown) and STAs 115. The STAs 115 may be within or outside of a coverage area 110-a associated with an AP (not shown) For instance, STA 115-a may be in master mode such that STA 115-b may connect to an external network, such as the Internet. In some cases, STA 115-b and STA 115-a may support dual bandwidth communications; that is, STA 115-b and STA 115-a may exchange information over two channels. Dual bandwidth communication may involve the use of multiple radios, or a single radio with multiple components for different frequency bands. Other STAs 115 may not be dual bandwidth capable. For example, STA 115-a may communicate with STA 115-c over a single channel. If one or both communication of STA 115-a′s channels are in a radar subband, there may be times when a radar 205 attempts to use the channel simultaneously with STA 115-b and STA 115-a. In such instances, STA 115-a may detect a radar signal from the radar 205 and switch to a different channel based on the detection.

In one example, STA 115-a may establish BSS functions via a primary channel and a secondary channel, each of which is within a radar subband. STA 115-a may perform a CAC for both channels before commencing communications. However, at some point STA 115-a may detect a radar signal from the radar 205 over the primary channel. Upon detection of the radar signal, STA 115-a may move the primary channel to the secondary channel. Accordingly, the SAP 105-a may move the secondary channel to a new channel, which may be in a radar or non-radar subband. In some cases, STA 115-a may detect a radar signal on the secondary channel. In such an instance, STA 115-a may switch the secondary channel to a new frequency while maintaining the same primary channel.

In another example, STA 115-a may establish BSS operation over a primary channel in a non-radar subband and a secondary channel in a radar subband. Upon selection of the secondary channel, STA 115-a may execute a CAC to determine if there are any signals associated with a radar application. If the CAC is successful (i.e., the channel is clear of radar signals), STA 115-a may advertise dual bandwidth communication capacity associated with the secondary channel. In some cases, STA 115-a may continue performing CACs for other radar channels. Accordingly, STA 115-a may build a list of available channels associated with successful CACs for future use. For example, when STA 115-a detects a radar signal on a channel and decides to switch to a new channel, STA 115-a may select the new channel based on the list of available radar subbands.

Thus, a master mode STA 115 may communicate with another STA 115 using two channels (e.g., a primary and secondary channel) simultaneously. The radar channels may be in radar or non-radar subbands. If the master mode STA 115 detects a radar blast on the primary channel, the STA 115 may move the primary channel to the secondary channel. In order to continue supporting dual bandwidth communications, the STA 115 may switch the secondary channel to a channel in a non-radar subband. However, in some cases the STA may choose the move the secondary channel to a radar channel. If the STA 115 detects a radar signal on the secondary channel, the STA 115 may move the secondary channel to a different frequency based on the detection. In some cases the STA 115 may determine if associated clients are capable of supporting dual bandwidth communications and adjust communications accordingly. Even after establishing two communication channels (radar or non-radar), the master mode STA 115 may continue to perform a channel availability check (CAC) on other channels to determine if the channels currently are occupied by radar signals. The STA 115 keep track of the channels associated with successful CACs in a table.

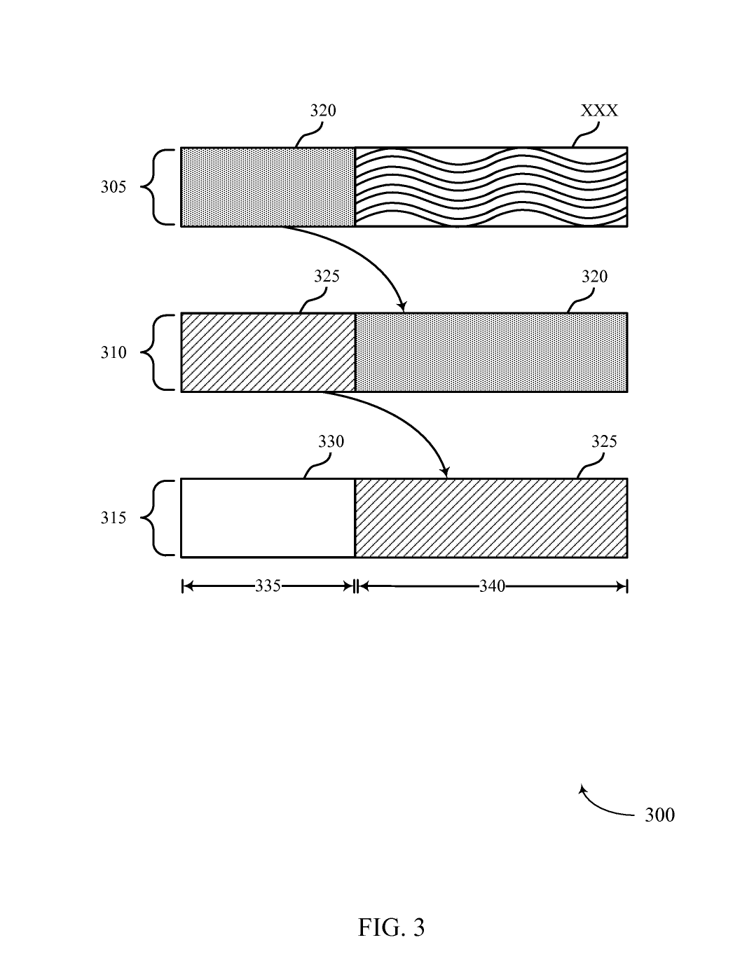

FIG. 3 illustrates an example of a dynamic channel configuration 300 for soft AP master mode using dual wideband channels in accordance with various aspects of the present disclosure. Dynamic channel configuration 300 may include a first channel 305, a second channel 310, and a third channel 315, each of which may be associated with SAP 105 communications, such as described with reference to FIGS. 1-2. First channel 305, second channel 310, and third channel 315 may be frequencies within radar or non-radar subbands. First channel 305, second channel 310, and third channel 315 may be associated with a STA 115 which is capable of supporting master mode such that the STA 115 may serve as an SAP for other STAs 115. Dynamic channel configuration 300 may also be used by an AP 105 as described with reference to FIG. 1.

Thus, a STA 115 in master mode may select first channel 305 to be associated with the primary channel of a BSS (e.g., the STA 115 may convey primary channel communications 320 over first channel 305). The STA 115 may also select second channel 310 to be associated with the secondary channel of a BSS (e.g., the STA 115 may convey secondary communications 325 over second channel 310). The STA 115 may identify third channel 315 as an available channel for communications. In some examples, third channel 315 may be associated with an available channel list such as described with reference to FIG. 2. Thus, during time period 335 the primary channel is first channel 305, the secondary channel is 310, and third channel 315 is unassociated with BSS communications.

The STA 115 may detect a radar signal on first channel 305, thus rendering first channel 305 unavailable for primary channel communications 320. Accordingly, the STA 115 may switch primary channel communications 320 to second channel 310, thereby freeing up first channel 305 for radar applications (i.e., second channel 310 may become the primary channel for the BSS).

The STA 115 may refrain from performing a CAC for second channel 310 due to the association of the second channel with secondary channel communications 325 (i.e., second channel 310 may be associated with a successful CAC that was performed when the STA 115 initially selected second channel to convey secondary channel communications 325). Accordingly, the STA 115 may avoid interruption or delay in communications by skipping CAC and immediately commencing primary channel communications 320.

Moving primary channel communications 320 to second channel 310 may render second channel 310 unavailable for secondary channel communications 325. Thus, the STA 115 may select a new channel to convey secondary channel communications 325. For example, the STA 115may choose third channel 315 to be associated with secondary channel communications 325 (i.e., third channel 315 may become the secondary channel for the BSS). Thus, during time period 340 first channel 305 may convey radar communications, second channel 310 may be the primary channel of the BSS, and third channel 315 may be the secondary channel of the BSS.

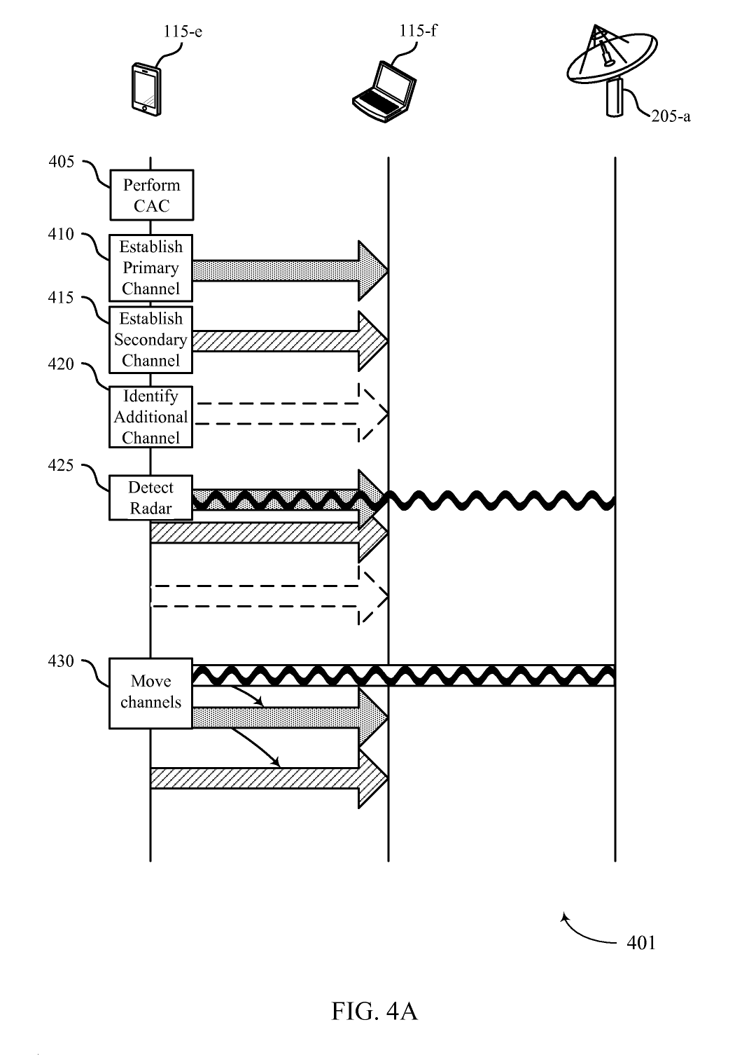

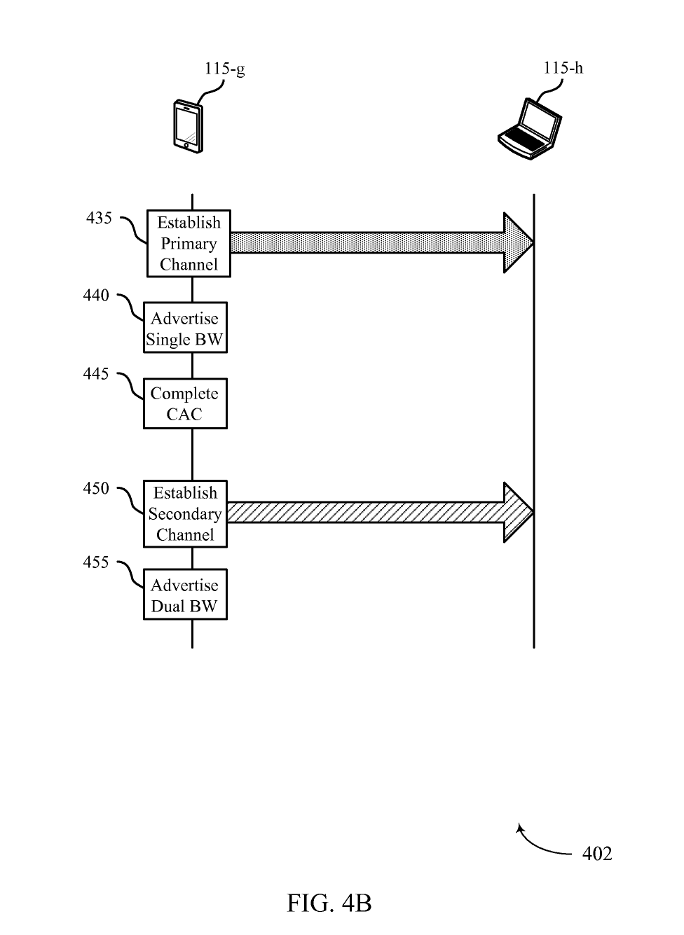

FIG. 4A illustrates an example of a process flow 401 for soft AP master mode using dual wideband channels in accordance with various aspects of the present disclosure. Process flow 401 may also include a STA 115-f, which may be an example of a STA 115 described herein with reference to FIGS. 1-2. Process flow 401 may include a STA 115-e, which may be an example of a STA 115 described herein with reference to FIGS. 1-2; that is, STA 115-e may support a master mode and serve as an SAP for STA 115-f. Radar 205-a may also be included in process flow 401.

At 405, STA 115-e may perform a successful channel availability check (CAC) on the first radar subband and the second radar subband. In some instances establishing the primary and secondary channel may be based at least in part on the successful CAC. STA 115-e may also activate a soft AP feature.

At 410, STA 115-e may establish a primary channel in a first radar subband and at 415 STA 115-e may establish a secondary channel in a second radar subband. Establishing the primary and secondary channel may be based at least in part on the soft AP operation. In some cases the STA 115-e may advertise a dual bandwidth capacity based at least in part on the primary channel and the secondary channel. At 420, STA 115-e may identify a third radar or non-radar subband available for communications.

At 425, STA 115-e may detect a radar signal in the first radar subband. Accordingly, at 430, STA 115-e may move the secondary channel to a non-radar subband. The movement of the secondary channel may be based at least in part on detecting the radar signal. STA 115-e may also move the primary channel to the second radar subband. The movement of the primary channel may be based at least in part on detecting the radar signal.

In some cases, STA 115-e may perform a successful CAC on the third radar subband based at least in part on moving the secondary channel to the non-radar subband. STA 115-e may move the secondary channel to the third radar subband based at least in part on the successful CAC on the third radar subband.

In some cases STA 115-e may perform a subsequent CAC on the first radar subband based at least in part on moving the primary channel to the second radar subband. STA 115-e may move one of the primary channel or the secondary channel to the first radar subband based at least in part on the successful CAC on the first radar subband. In some cases, performing a CAC may include using a first radio to communicate on one of the channels while concurrently performing the CAC on the other of the channels.

FIG. 4B illustrates an example of a process flow 402 for soft AP master mode using dual wideband channels in accordance with various aspects of the present disclosure. Process flow 402 may also include a STA 115-h, which may be an example of a STA 115 described herein with reference to FIGS. 1-2. Process flow 402 may include a STA 115-g, which may be an example of a STA 115 described herein with reference to FIGS. 1-2; that is, STA 115-g may support a master mode and serve as an SAP for STA 115-h.

At 435, STA 115-g may establish a primary channel in a non-radar subband. At 440, STA 115g may advertise a single bandwidth capacity based at least in part on the primary channel.

At 445, STA 115g may complete a successful CAC on a radar subband for a secondary channel. The CAC may be performed after advertising the single bandwidth capacity. At 450, STA 115g may establish the secondary channel in the radar subband based at least in part on the successful CAC. Thus, at 455, STA 115g may advertise a dual bandwidth capacity based at least in part on the primary channel and the successful CAC.

In some cases STA 115g may communicate over the primary channel using a first radio while concurrently performing the CAC on the radar subband using a second radio.

STA 115g may also perform a second successful CAC on a second radar subband. In some cases, STA 115g may maintain a list of available subbands (e.g., subbands associated with successful CACs). Thus, STA 115g may update the list of available subbands by adding the second radar subband. In some examples, STA 115g may determine that the list contains a threshold number of subbands. Thus, in some cases advertising the dual bandwidth capacity may be based on the determination.

In some cases, STA 115g may detect a radar signal in the radar subband. Accordingly, STA 115g may move the secondary channel to the different subband. The movement of the secondary channel may be based at least in part on detecting the radar signal in the radar subband.

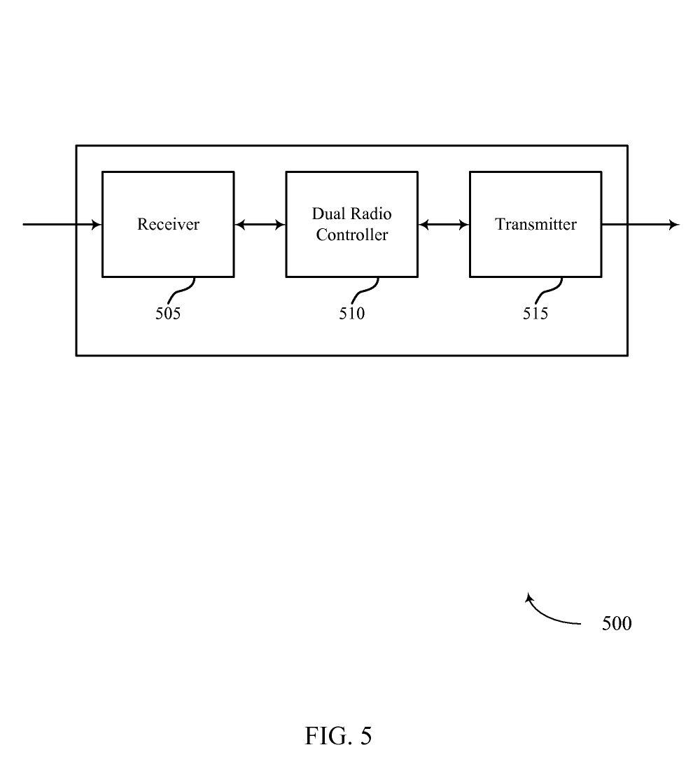

FIG. 5 shows a block diagram of a wireless device 500 configured for soft AP master mode using dual wideband channels in accordance with various aspects of the present disclosure. Wireless device 500 may be an example of aspects of a STA 115 described with reference to FIGS. 1-4. Wireless device 500 may include a receiver 505, a dual radio controller 510, or a transmitter 515. Wireless device 500 may also include a processor. Each of these components may be in communication with each other.

The receiver 505 may receive information such as packets, user data, or control information associated with various information channels (e.g., control channels, data channels, and information related to soft AP master mode using dual wideband channels, etc.). Information may be passed on to the dual radio controller 510, and to other components of wireless device 500.

The dual radio controller 510 may establish a primary channel in a first radar subband and a secondary channel in a second radar subband, detect a radar signal in the first radar subband, move the secondary channel to a non-radar subband based at least in part on detecting the radar signal, and move the primary channel to the second radar subband based at least in part on detecting the radar signal and moving the secondary channel.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas.

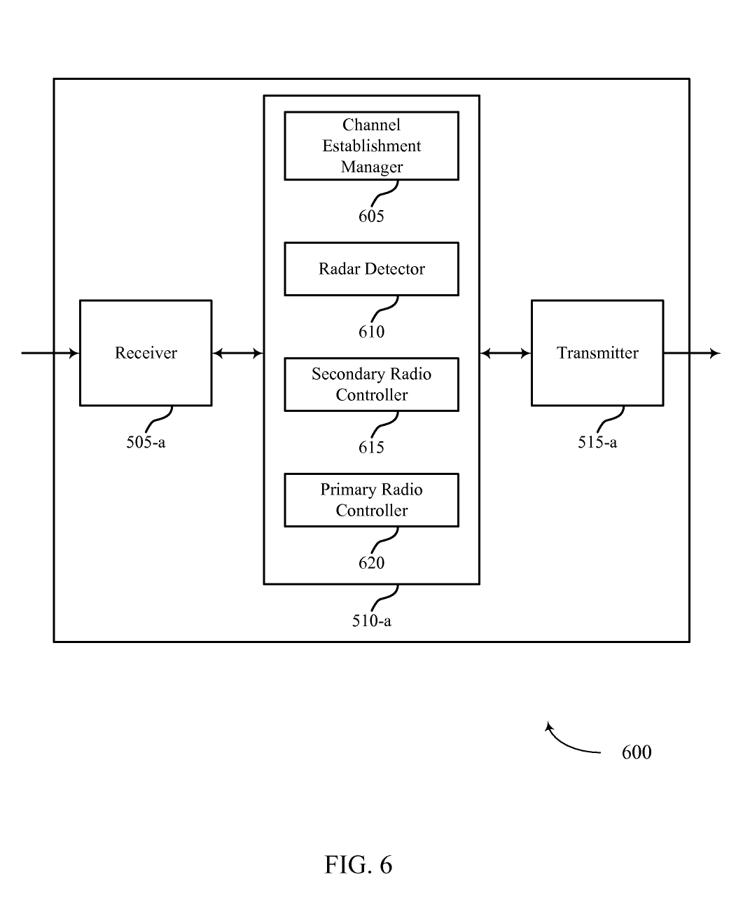

FIG. 6 shows a block diagram of a wireless device 600 for soft AP master mode using dual wideband channels in accordance with various aspects of the present disclosure. Wireless device 600 may be an example of aspects of a wireless device 500 or a STA 115 described with reference to FIGS. 1-5. Wireless device 600 may include a receiver 505a, a dual radio controller 510a, or a transmitter 515a. Wireless device 600 may also include a processor. Each of these components may be in communication with each other. The dual radio controller 510a may also include a channel establishment manager 605, a radar detector 610, a secondary radio controller 615, and a primary radio controller 620.

The receiver 505a may receive information which may be passed on to dual radio controller 510a, and to other components of the wireless device 600. The dual radio controller 510a may perform the operations described herein with reference to FIG. 5. The transmitter 515a may transmit signals received from other components of wireless device 600.

The channel establishment manager 605 may establish a primary channel in a first radar subband and a secondary channel in a second radar subband as described herein with reference to FIGS. 2-4. The channel establishment manager 605 may also establish a primary channel in a non-radar subband. The channel establishment manager 605 may establish the secondary channel in the radar subband based at least in part on the successful CAC.

The radar detector 610 may detect a radar signal in a radar subband as described herein with reference to FIGS. 2-4.

The secondary radio controller 615 may move the secondary channel to a non-radar subband based at least in part on detecting the radar signal as described herein with reference to FIGS. 2-4. The secondary radio controller 615 may also move the secondary channel to a third radar subband based at least in part on the successful CAC on the third radar subband. The secondary radio controller 615 may also move the secondary channel to the different subband based at least in part on detecting the radar signal in the radar subband.

The primary radio controller 620 may move the primary channel to the second radar subband based at least in part on detecting the radar signal and moving the secondary channel as described herein with reference to FIGS. 2-4. The primary radio controller 620 may also communicate over the primary channel using a first radio while concurrently performing the CAC on the radar subband using a second radio.

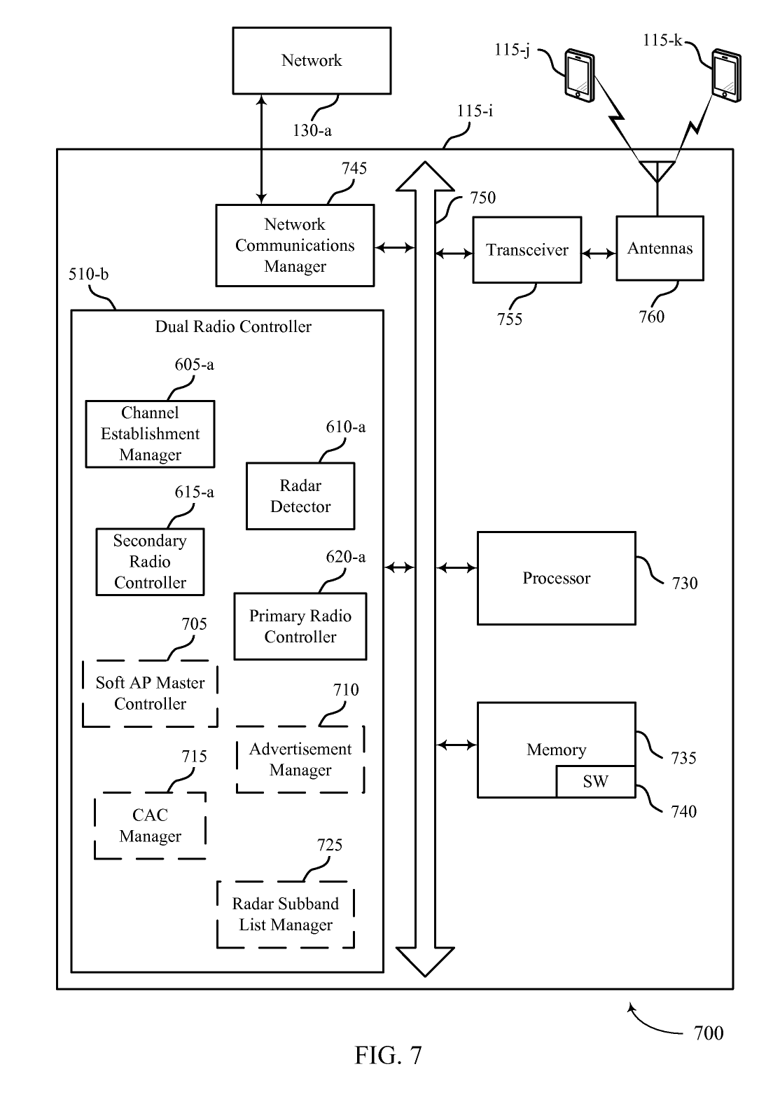

FIG. 7 shows a diagram of a system 700 including STA 115i configured for soft AP master mode using dual wideband channels in accordance with various aspects of the present disclosure. STA 115i may be an example of a wireless device 500, a wireless device 600, or a STA 115 described herein with reference to FIGS. 1, 2 and 5-7. STA 115i may include a dual radio controller 510b, which may be an example of a dual radio controller described with reference to FIGS. 5-6. STA 115i may also include components for bi-directional voice and data communications including components for transmitting communications and components for receiving communications. For example, STA 115i may communicate bi-directionally with an AP 105 (not shown) or a STA 115 (e.g., STA 115j and STA 115k). STA 115i may communicate with an external network 130a through network communications manager 745. In some cases, STA 115i facilitate communications between the network 130a and STAs 115 such as described with reference to FIGS. 1-4.

The dual radio controller 510b may include a channel establishment manager 605a, a radar detector 610a, a secondary radio controller 615a, and a primary radio controller 620a. Each of these modules may perform the functions described herein with reference to FIG. 6. The dual radio controller 510b may also include a soft AP master controller 705, an advertisement manager 710, a CAC manager 715, and a radar subband list manager 725.

The soft AP master controller 705 may activate a soft AP feature. In some cases, establishing a primary and secondary channel may be based at least in part on the soft AP feature as described herein with reference to FIGS. 2-4.

The advertisement manager 710 may advertise a dual bandwidth capacity based at least in part on a primary channel and a secondary channel as described herein with reference to FIGS. 2-4. The advertisement manager 710 may also advertise a single bandwidth capacity based at least in part on the primary channel. The advertisement manager 710 may also advertise a dual bandwidth capacity based at least in part on the primary channel and the successful CAC. The advertisement manager 710 may also advertise the dual bandwidth capacity is based at least in part on the determination.

The CAC manager 715 may perform a successful channel availability check (CAC) on a first radar subband and the second radar subband, wherein establishing the primary and secondary channel is based at least in part on the successful CAC as described herein with reference to FIGS. 2-4. The CAC manager 715 may also perform a successful CAC on a third radar subband based at least in part on moving the secondary channel to the non-radar subband. The CAC manager 715 may perform the CAC on the first radar subband based at least in part on moving the primary channel to the second radar subband. In some cases, performing the CAC comprises using a first radio to communicate on one of the channels while concurrently performing the CAC on the other of the channels. The CAC manager 715 may complete the CAC on a radar subband for a secondary channel after advertising the single bandwidth capacity.

The dual radio controller 720 may move one of the primary channel or the secondary channel to the first radar subband based at least in part on the successful CAC on the first radar subband as described herein with reference to FIGS. 2-4.

The radar subband list manager 725 may add a radar subband to a list of available radar subbands as described herein with reference to FIGS. 2-4. The radar subband list manager 725 may also determine that the list contains a threshold number of subbands.

STA 115i may also include a processor 730, and memory 735 (including software (SW) 740), a transceiver 755, and antenna(s) 760, each of which may communicate, directly or indirectly, with one another (e.g., via buses 750). The transceiver 755 may communicate bi-directionally, via the antenna(s) 760 or wired or wireless links, with networks, as described above. For example, the transceiver 755 may communicate bi-directionally with an AP 105 or another STA 115. The transceiver 755 may include a modem to modulate the packets and provide the modulated packets to the antenna(s) 760 for transmission, and to demodulate packets received from the antenna(s) 760. While STA 115i may include a single antenna 760, STA 115i may also have multiple antennas 760 capable of concurrently transmitting or receiving multiple wireless transmissions. For example, antennas 760 may be associated with dual radios such that STA 115i may communicate over two channels at the same time.

The memory 735 may include random access memory (RAM) and read only memory (ROM). The memory 735 may store computer-readable, computer-executable software/firmware code 740 including instructions that, when executed, cause the processor 730 to perform various functions described herein (e.g., soft AP master mode using dual wideband channels, etc.). Alternatively, the software/firmware code 740 may not be directly executable by the processor 730 but cause a computer (e.g., when compiled and executed) to perform functions described herein. The processor 730 may include an intelligent hardware device (e.g., a central processing unit (CPU), a microcontroller, an ASIC, etc.).

The components of wireless device 500, wireless device 600, or dual radio controller 510 may, individually or collectively, be implemented with at least one ASIC adapted to perform some or all of the applicable functions in hardware. Alternatively, the functions may be performed by other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by general or application-specific processors.

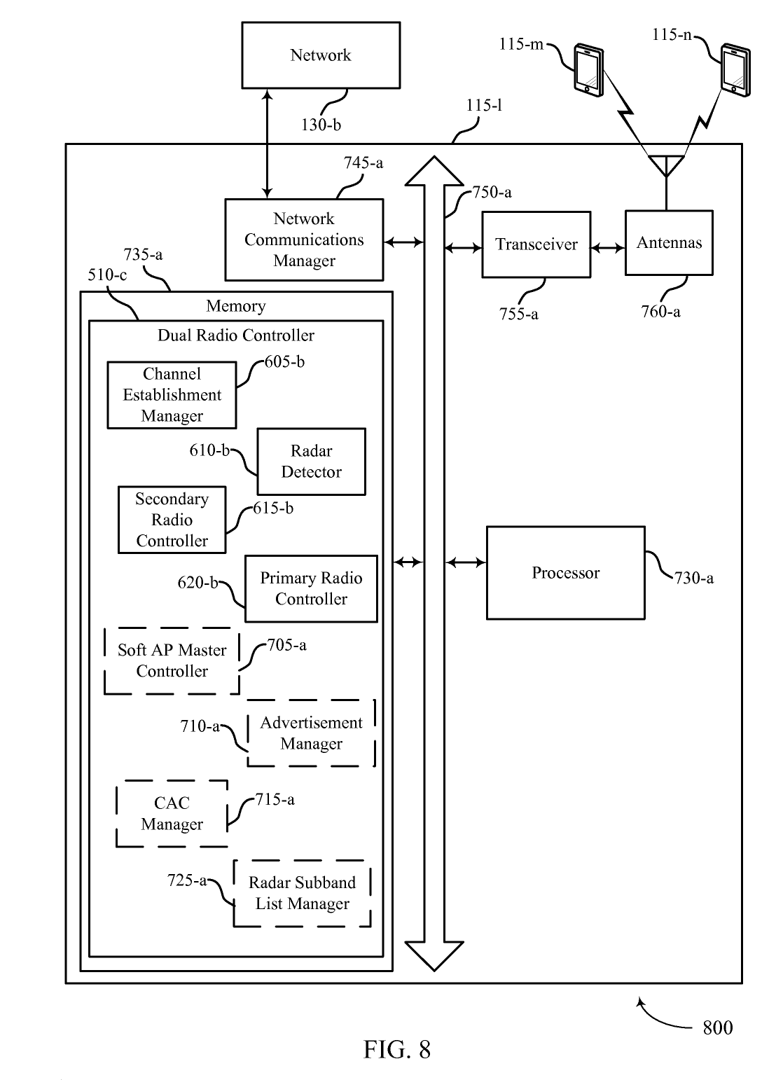

FIG. 8 shows a diagram of a system 800 including STA 115-l configured for soft AP master mode using dual wideband channels in accordance with various aspects of the present disclosure. STA 115-l may be an example of a wireless device 500, a wireless device 600, or a STA 115 described herein with reference to FIGS. 1, 2, and 4-7. STA 115-l may include a processor 730a, memory 735a, transceiver 755a, and antenna(s) 760a, each of which may perform the functions described above with reference to FIG. 7, and each of which may communicate, directly or indirectly, with one another (e.g., via bus system 750a).

In the present example, the memory 735a may include software that performs the functionality of dual radio controller 510c. For example, memory 735a may include software that, when compiled and executed, performs the functionality of a channel establishment manager 605b, radar detector 610b, secondary radio controller 615b, primary radio controller 620b, soft AP master controller 705a, advertisement manager 710a, CAC manager 715a, and radar subband list manager 725a, such as described with reference to FIGS. 5-7. In some cases, a subset of the functionality of dual radio controller 510c is included in memory 735a; in other cases, all of the functionality may be implemented as software executed by the processor 730a to cause STA 115-l to perform the functions of dual radio controller 510c. For example, the functionality of the channel establishment manager 605b and radar detector 610d may be accomplished by software included memory 735a, while the functionality of secondary radio controller 615b, primary radio controller 620b, soft AP master controller 705a, advertisement manager 710a, CAC manager 715a, and radar subband list manager 725a may be accomplished using hardware. Regardless of the distribution of functionality, STA 115-l may implement the functions described herein to serve as an SAP for STA 115m or STA 115n.

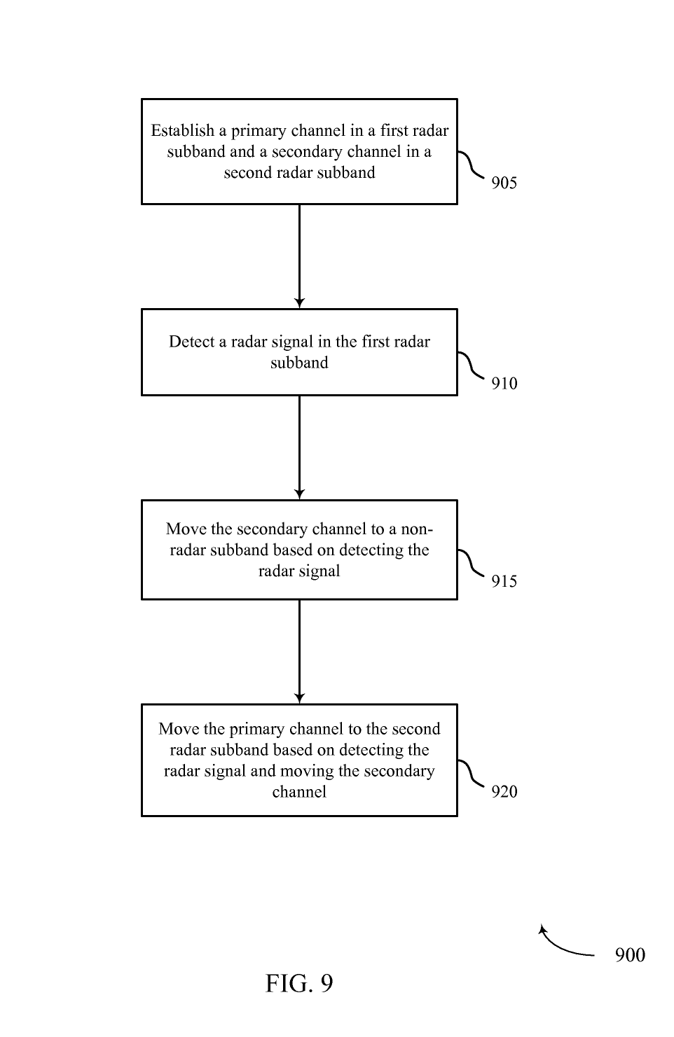

FIG. 9 shows a flowchart illustrating a method 900 for soft AP master mode using dual wideband channels in accordance with various aspects of the present disclosure. The operations of method 900 may be implemented by a STA 115 or its components as described with reference to FIGS. 1-8. For example, the operations of method 900 may be performed by the dual radio controller 510 as described with reference to FIGS. 5-8. In some examples, an AP 105 may execute a set of codes to control the functional elements of the STA 115 to perform the functions described below. Additionally or alternatively, the STA 115 may perform aspects the functions described below using special-purpose hardware.

At block 905, the STA 115 may establish a primary channel in a first radar subband and a secondary channel in a second radar subband as described herein with reference to FIGS. 2-4. In certain examples, the operations of block 905 may be performed by the channel establishment manager 605 as described herein with reference to FIG. 6.

At block 910, the STA 115 may detect a radar signal in the first radar subband as described herein with reference to FIGS. 2-4. In certain examples, the operations of block 910 may be performed by the radar detector 610 as described herein with reference to FIG. 6.

At block 915, the STA 115 may move the secondary channel to a non-radar subband based at least in part on detecting the radar signal as described herein with reference to FIGS. 2-4. In certain examples, the operations of block 915 may be performed by the secondary radio controller 615 as described herein with reference to FIG. 6.

At block 920, the STA 115 may move the primary channel to the second radar subband based at least in part on detecting the radar signal and moving the secondary channel as described herein with reference to FIGS. 2-4. In certain examples, the operations of block 920 may be performed by the primary radio controller 620 as described herein with reference to FIG. 6.

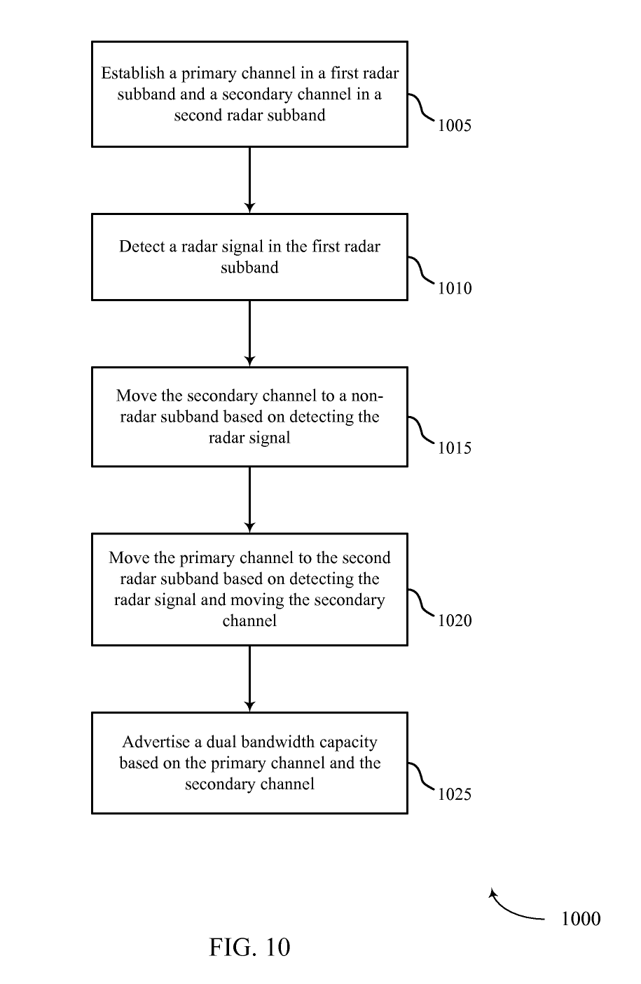

FIG. 10 shows a flowchart illustrating a method 1000 for soft AP master mode using dual wideband channels in accordance with various aspects of the present disclosure. The operations of method 1000 may be implemented by a STA 115 or its components as described with reference to FIGS. 1-8. For example, the operations of method 1000 may be performed by the dual radio controller 510 as described with reference to FIGS. 5-8. In some examples, a STA 115 may execute a set of codes to control the functional elements of the

STA 115 to perform the functions described below. Additionally or alternatively, the STA 115 may perform aspects the functions described below using special-purpose hardware. The method 1000 may also incorporate aspects of method 900 of FIG. 9.

At block 1005, the STA 115 may establish a primary channel in a first radar subband and a secondary channel in a second radar subband as described herein with reference to FIGS. 2-4. In certain examples, the operations of block 1005 may be performed by the channel establishment manager 605 as described herein with reference to FIG. 6.

At block 1010, the STA 115 may detect a radar signal in the first radar subband as described herein with reference to FIGS. 2-4. In certain examples, the operations of block 1010 may be performed by the radar detector 610 as described herein with reference to FIG.

6.

At block 1015, the STA 115 may move the secondary channel to a non-radar subband based at least in part on detecting the radar signal as described herein with reference to FIGS. 2-4. In certain examples, the operations of block 1015 may be performed by the secondary radio controller 615 as described herein with reference to FIG. 6.

At block 1020, the STA 115 may move the primary channel to the second radar subband based at least in part on detecting the radar signal and moving the secondary channel as described herein with reference to FIGS. 2-4. In certain examples, the operations of block 1020 may be performed by the primary radio controller 620 as described herein with reference to FIG. 6.

At block 1025, the STA 115 may advertise a dual bandwidth capacity based at least in part on the primary channel and the secondary channel as described herein with reference to FIGS. 2-4. In certain examples, the operations of block 1025 may be performed by the advertisement manager 710 as described herein with reference to FIG. 7.

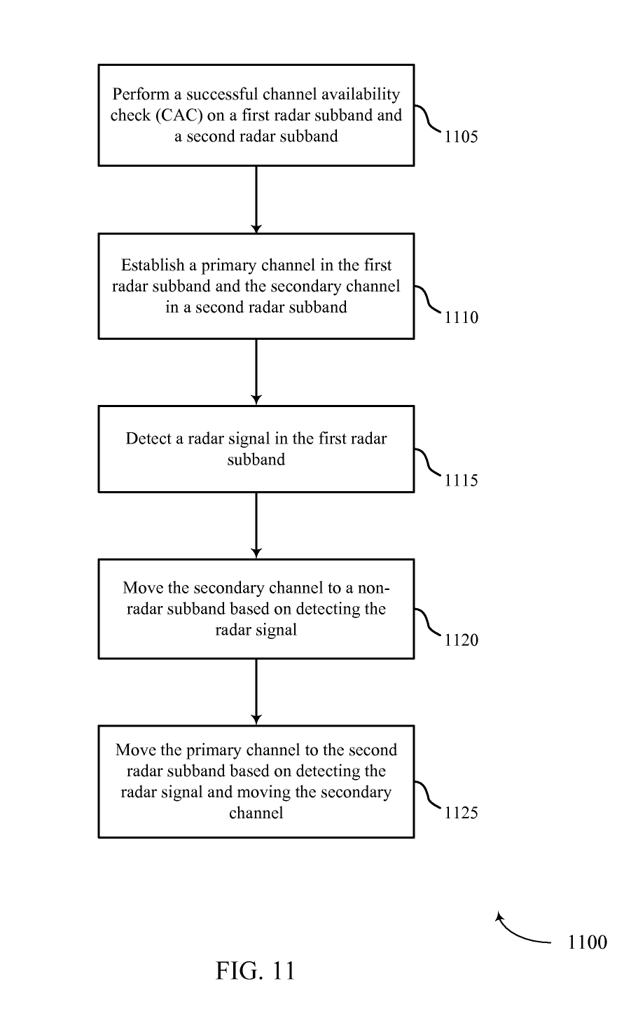

FIG. 11 shows a flowchart illustrating a method 1100 for soft AP master mode using dual wideband channels in accordance with various aspects of the present disclosure. The operations of method 1100 may be implemented by a STA 115 or its components as described with reference to FIGS. 1-8. For example, the operations of method 1100 may be performed by the dual radio controller 510 as described with reference to FIGS. 5-8. In some examples, an AP 105 may execute a set of codes to control the functional elements of the STA 115 to perform the functions described below. Additionally or alternatively, the STA 115 may perform aspects the functions described below using special-purpose hardware. The method 1100 may also incorporate aspects of methods 900, and 1000 of FIGS. 9-10.

At block 1105, the STA 115 may perform a successful channel availability check (CAC) on the first radar subband and the second radar subband, wherein establishing the primary and secondary channel is based at least in part on the successful CAC as described herein with reference to FIGS. 2-4. In certain examples, the operations of block 1105 may be performed by the CAC manager 715 as described herein with reference to FIG. 7.

At block 1110, the STA 115 may establish a primary channel in a first radar subband and a secondary channel in a second radar subband as described herein with reference to FIGS. 2-4. In certain examples, the operations of block 1110 may be performed by the channel establishment manager 605 as described herein with reference to FIG. 6.

At block 1115, the STA 115 may detect a radar signal in the first radar subband as described herein with reference to FIGS. 2-4. In certain examples, the operations of block 1115 may be performed by the radar detector 610 as described herein with reference to FIG. 6.

At block 1120, the STA 115 may move the secondary channel to a non-radar subband based at least in part on detecting the radar signal as described herein with reference to FIGS. 2-4. In certain examples, the operations of block 1120 may be performed by the secondary radio controller 615 as described herein with reference to FIG. 6.

At block 1125, the STA 115 may move the primary channel to the second radar subband based at least in part on detecting the radar signal and moving the secondary channel as described herein with reference to FIGS. 2-4. In certain examples, the operations of block 1125 may be performed by the primary radio controller 620 as described herein with reference to FIG. 6.

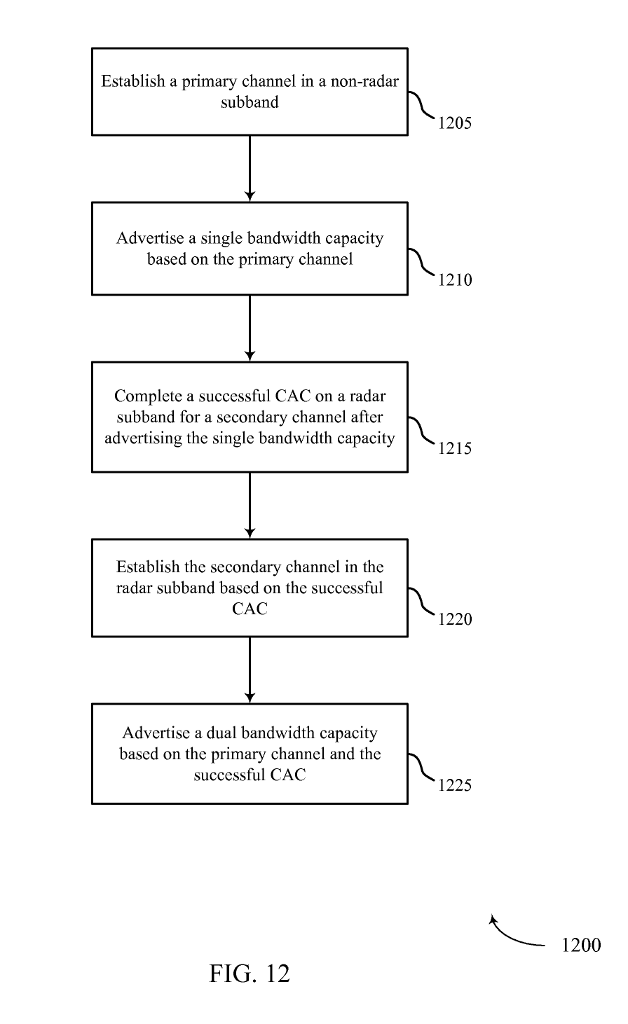

FIG. 12 shows a flowchart illustrating a method 1200 for soft AP master mode using dual wideband channels in accordance with various aspects of the present disclosure. The operations of method 1200 may be implemented by a STA 115 or its components as described with reference to FIGS. 1-8. For example, the operations of method 1200 may be performed by the dual radio controller 510 as described with reference to FIGS. 5-8. In some examples, a STA 115 may execute a set of codes to control the functional elements of the STA 115 to perform the functions described below. Additionally or alternatively, the AP 105 may perform aspects the functions described below using special-purpose hardware. The method 1200 may also incorporate aspects of methods 900, 1000, and 1100 of FIGS. 9-11.

At block 1205, the STA 115 may establish a primary channel in a non-radar subband as described herein with reference to FIGS. 2-4. In certain examples, the operations of block 1205 may be performed by the channel establishment manager 605 as described herein with reference to FIG. 6.

At block 1210, the STA 115 may advertise a single bandwidth capacity based at least in part on the primary channel as described herein with reference to FIGS. 2-4. In certain examples, the operations of block 1210 may be performed by the advertisement manager 710 as described herein with reference to FIG. 7.

At block 1215, the STA 115 may complete a successful CAC on a radar subband for a secondary channel after advertising the single bandwidth capacity as described herein with reference to FIGS. 2-4. In certain examples, the operations of block 1215 may be performed by the CAC manager 715 as described herein with reference to FIG. 7.

At block 1220, the STA 115 may establish the secondary channel in the radar subband based at least in part on the successful CAC as described herein with reference to FIGS. 2-4. In certain examples, the operations of block 1220 may be performed by the channel establishment manager 605 as described herein with reference to FIG. 6.

At block 1225, the STA 115 may advertise a dual bandwidth capacity based at least in part on the primary channel and the successful CAC as described herein with reference to FIGS. 2-4. In certain examples, the operations of block 1225 may be performed by the advertisement manager 710 as described herein with reference to FIG. 7.

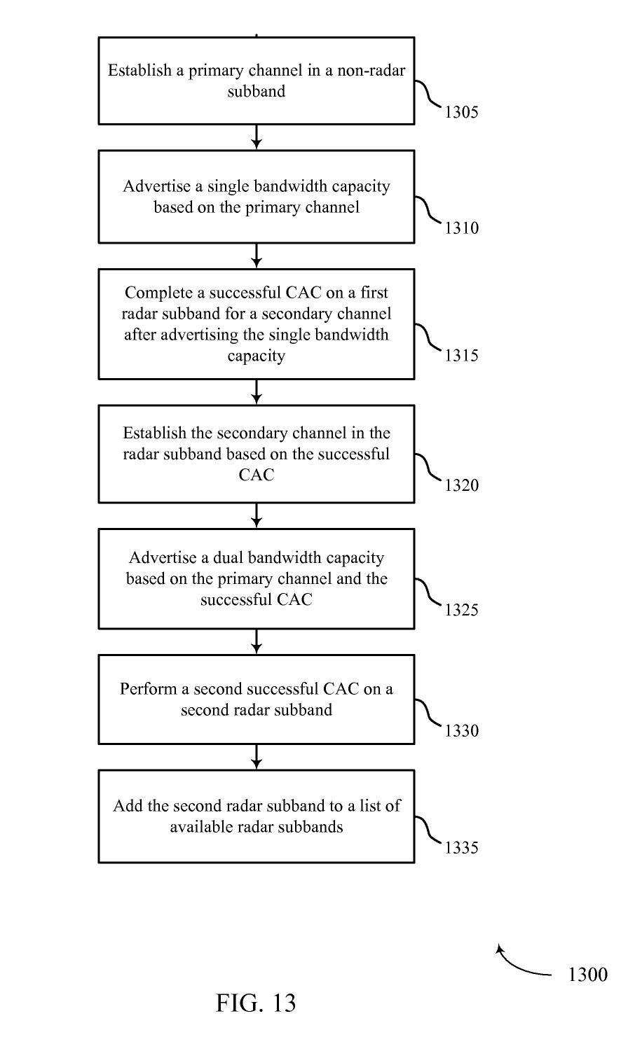

FIG. 13 shows a flowchart illustrating a method 1300 for soft AP master mode using dual wideband channels in accordance with various aspects of the present disclosure. The operations of method 1300 may be implemented by a STA 115 or its components as described with reference to FIGS. 1-8. For example, the operations of method 1300 may be performed by the dual radio controller 510 as described with reference to FIGS. 5-8. In some examples, an AP 105 may execute a set of codes to control the functional elements of the STA 115 to perform the functions described below. Additionally or alternatively, the STA 115 may perform aspects the functions described below using special-purpose hardware. The method 1300 may also incorporate aspects of methods 900, 1000, 1100, and 1200 of FIGS. 9-12.

At block 1305, the STA 115 may establish a primary channel in a non-radar subband as described herein with reference to FIGS. 2-4. In certain examples, the operations of block 1305 may be performed by the channel establishment manager 605 as described herein with reference to FIG. 6.

At block 1310, the STA 115 may advertise a single bandwidth capacity based at least in part on the primary channel as described herein with reference to FIGS. 2-4. In certain examples, the operations of block 1310 may be performed by the advertisement manager 710 as described herein with reference to FIG. 7.

At block 1315, the STA 115 may complete a successful CAC on a first radar subband for a secondary channel after advertising the single bandwidth capacity as described herein with reference to FIGS. 2-4. In certain examples, the operations of block 1315 may be performed by the CAC manager 715 as described herein with reference to FIG. 7.

At block 1320, the STA 115 may establish the secondary channel in the first radar subband based at least in part on the successful CAC as described herein with reference to FIGS. 2-4. In certain examples, the operations of block 1320 may be performed by the channel establishment manager 605 as described herein with reference to FIG. 6.

At block 1325, the STA 115 may advertise a dual bandwidth capacity based at least in part on the primary channel and the successful CAC as described herein with reference to FIGS. 2-4. In certain examples, the operations of block 1325 may be performed by the advertisement manager 710 as described herein with reference to FIG. 7.

At block 1330, the STA 115 may perform a second successful CAC on a second radar subband as described herein with reference to FIGS. 2-4. In certain examples, the operations of block 1330 may be performed by the CAC manager 715 as described herein with reference to FIG. 7.

At block 1335, the STA 115 may add the second radar subband to a list of available radar subbands as described herein with reference to FIGS. 2-4. In certain examples, the operations of block 1335 may be performed by the radar subband list manager 725 as described herein with reference to FIG. 7.

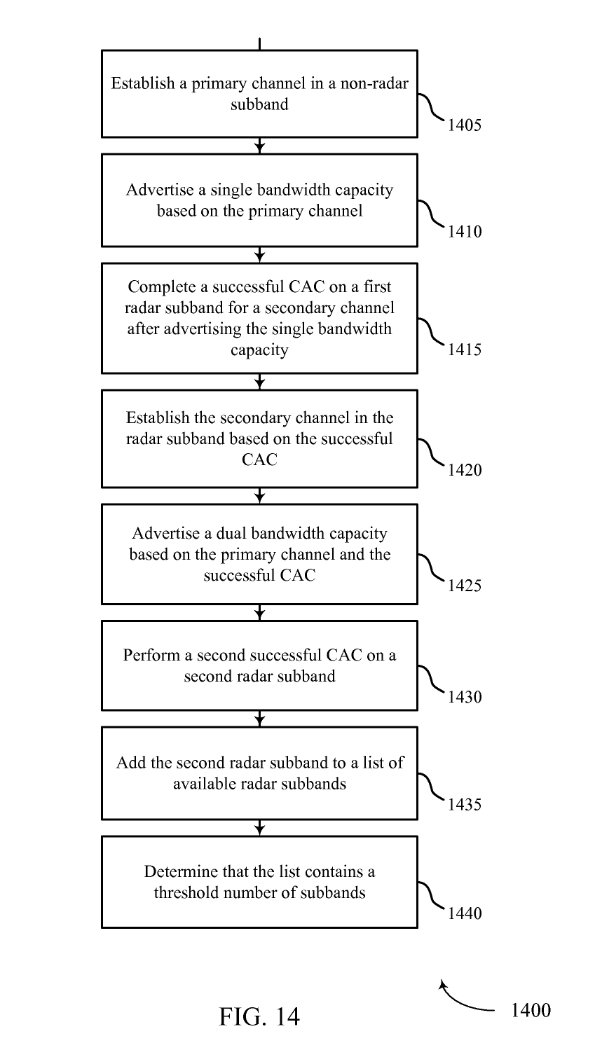

FIG. 14 shows a flowchart illustrating a method 1400 for soft AP master mode using dual wideband channels in accordance with various aspects of the present disclosure. The operations of method 1400 may be implemented by a STA 115 or its components as described with reference to FIGS. 1-8. For example, the operations of method 1400 may be performed by the dual radio controller 510 as described with reference to FIGS. 5-8. In some examples, a STA 115 may execute a set of codes to control the functional elements of the STA 115 to perform the functions described below. Additionally or alternatively, the STA 115 may perform aspects the functions described below using special-purpose hardware. The method 1400 may also incorporate aspects of methods 900, 1000, 1100, 1200, and 1300 of FIGS. 9-13.

At block 1405, the STA 115 may establish a primary channel in a non-radar subband as described herein with reference to FIGS. 2-4. In certain examples, the operations of block 1405 may be performed by the channel establishment manager 605 as described herein with reference to FIG. 6.

At block 1410, the STA 115 may advertise a single bandwidth capacity based at least in part on the primary channel as described herein with reference to FIGS. 2-4. In certain examples, the operations of block 1410 may be performed by the advertisement manager 710 as described herein with reference to FIG. 7.

At block 1415, the STA 115 may complete a successful CAC on a first radar subband for a secondary channel after advertising the single bandwidth capacity as described herein with reference to FIGS. 2-4. In certain examples, the operations of block 1415 may be performed by the CAC manager 715 as described herein with reference to FIG. 7.

At block 1420, the STA 115 may establish the secondary channel in the first radar subband based at least in part on the successful CAC as described herein with reference to FIGS. 2-4. In certain examples, the operations of block 1420 may be performed by the channel establishment manager 605 as described herein with reference to FIG. 6.

At block 1425, the STA 115 may advertise a dual bandwidth capacity based at least in part on the primary channel and the successful CAC as described herein with reference to FIGS. 2-4. In certain examples, the operations of block 1425 may be performed by the advertisement manager 710 as described herein with reference to FIG. 7.

At block 1430, the STA 115 may perform a second successful CAC on a second radar subband as described herein with reference to FIGS. 2-4. In certain examples, the operations of block 1430 may be performed by the CAC manager 715 as described herein with reference to FIG. 7.

At block 1435, the STA 115 may add the second radar subband to a list of available radar subbands as described herein with reference to FIGS. 2-4. In certain examples, the operations of block 1435 may be performed by the radar subband list manager 725 as described herein with reference to FIG. 7.

At block 1440, the STA 115 may determine that the list contains a threshold number of subbands as described herein with reference to FIGS. 2-4. In certain examples, the operations of block 1440 may be performed by the radar subband list manager 725 as described herein with reference to FIG. 7.

At block 1445, the STA 115 may advertise the dual bandwidth capacity is based at least in part on the determination as described herein with reference to FIGS. 2-4. In certain examples, the operations of block 1445 may be performed by the advertisement manager 710 as described herein with reference to FIG. 7.

Thus, methods 900, 1000, 1100, 1200, 1300, and 1400 may provide for soft AP master mode using dual wideband channels. It should be noted that methods 900, 1000, 1100, 1200, 1300, and 1400 describe possible implementation, and that the operations and the steps may be rearranged or otherwise modified such that other implementations are possible. In some examples, aspects from two or more of the methods 900, 1000, 1100, 1200, 1300, and 1400 may be combined.

The detailed description set forth above in connection with the appended drawings describes exemplary configurations and does not represent all the examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication, comprising:
establishing a primary channel in a first radar subband and a secondary channel in a second radar subband;
detecting a radar signal in the first radar subband;
moving the secondary channel to a non-radar subband based at least in part on detecting the radar signal; and
moving the primary channel to the second radar subband based at least in part on detecting the radar signal and moving the secondary channel.

2. The method of claim 1, further comprising:
activating a soft access point (AP) feature, wherein establishing the primary and secondary channel is based at least in part on the soft AP feature.

3. The method of claim 1, further comprising:
advertising a dual bandwidth capacity based at least in part on the primary channel and the secondary channel.

4. The method of claim 1, further comprising:
performing a successful channel availability check (CAC) on the first radar subband and the second radar subband, wherein establishing the primary and secondary channel is based at least in part on the successful CAC.

5. The method of claim 4, further comprising:
performing a successful CAC on a third radar subband based at least in part on moving the secondary channel to the non-radar subband; and
moving the secondary channel to the third radar subband based at least in part on the successful CAC on the third radar subband.

6. The method of claim 4, further comprising:
performing a successful CAC on the first radar subband based at least in part on moving the primary channel to the second radar subband; and
moving one of the primary channel or the secondary channel to the first radar subband based at least in part on the successful CAC on the first radar subband.

7. The method of claim 4, further comprising:
performing the successful CAC comprises using a first radio to communicate on one of the channels while concurrently performing the successful CAC on the other of the channels.

8. A method of wireless communication, comprising:
establishing a primary channel in a non-radar subband;
advertising a single bandwidth capacity based at least in part on the primary channel;
completing a successful CAC on a radar subband for a secondary channel after advertising the single bandwidth capacity;
establishing the secondary channel in the radar subband based at least in part on the successful CAC; and
advertising a dual bandwidth capacity based at least in part on the primary channel and the successful CAC.

9. The method of claim 8, further comprising:
communicating over the primary channel using a first radio while concurrently performing the successful CAC on the radar subband using a second radio.

10. The method of claim 8, wherein the radar subband comprises a first radar subband;
the method further comprising performing a second successful CAC on a second radar subband; and
adding the second radar subband to a list of available radar subbands.

11. The method of claim 10, further comprising:
determining that the list contains a threshold number of subbands; and
advertising the dual bandwidth capacity is based at least in part on the determination.

12. The method of claim 10, further comprising:
detecting a radar signal in the radar subband; and
moving the secondary channel to a different subband based at least in part on detecting the radar signal in the radar subband.

13. An apparatus for wireless communication, comprising:
a channel establishment manager for establishing a primary channel in a first radar subband and a secondary channel in a second radar subband;
a radar detector for detecting a radar signal in the first radar subband;
a secondary radio controller for moving the secondary channel to a non-radar subband based at least in part on detecting the radar signal; and
a primary radio controller for moving the primary channel to the second radar subband based at least in part on detecting the radar signal and moving the secondary channel.

14. The apparatus of claim 13, further comprising:
a soft access point (AP) master controller for activating a soft AP feature, wherein establishing the primary and secondary channel is based at least in part on the soft AP feature.

15. The apparatus of claim 13, further comprising:
an advertisement manager for advertising a dual bandwidth capacity based at least in part on the primary channel and the secondary channel.

16. The apparatus of claim 13, further comprising:
a CAC manager for performing a successful channel availability check (CAC) on the first radar subband and the second radar subband, wherein establishing the primary and secondary channel is based at least in part on the successful CAC.

17. The apparatus of claim 16, further comprising:
a component for performing a successful CAC on a third radar subband based at least in part on moving the secondary channel to the non-radar subband; and
the secondary radio controller for moving the secondary channel to the third radar subband based at least in part on the successful CAC on the third radar subband.

18. The apparatus of claim 16, further comprising:
a component for performing a successful CAC on the first radar subband based at least in part on moving the primary channel to the second radar subband; and
a dual radio controller for moving one of the primary channel or the secondary channel to the first radar subband based at least in part on the successful CAC on the first radar subband.

19. The apparatus of claim 16, further comprising:
a component for performing the successful CAC using a first radio to communicate on one of the channels while concurrently performing the successful CAC on the other of the channels.

20. An apparatus for wireless communication, comprising:
a channel establishment manager for establishing a primary channel in a non-radar subband;
an advertisement manager for advertising a single bandwidth capacity based at least in part on the primary channel;
a CAC manager for completing a successful CAC on a radar subband for a secondary channel after advertising the single bandwidth capacity;
the channel establishment manager for establishing the secondary channel in the radar subband based at least in part on the successful CAC; and
the advertisement manager for advertising a dual bandwidth capacity based at least in part on the primary channel and the successful CAC.

21. The apparatus of claim 20, further comprising:
a primary radio controller for communicating over the primary channel using a first radio while concurrently performing the successful CAC on the radar subband using a second radio.

22. The apparatus of claim 20, wherein the radar subband comprises a first radar subband;
the apparatus further comprising a component for performing a second successful CAC on a second radar subband; and
a radar subband list manager for adding the second radar subband to a list of available radar subbands.

23. The apparatus of claim 22, further comprising:
the radar subband list manager for determining that the list contains a threshold number of subbands; and
the advertisement manager for advertising the dual bandwidth capacity is based at least in part on the determination.

24. The apparatus of claim 22, further comprising:
a radar detector for detecting a radar signal in the radar subband; and
a secondary radio controller for moving the secondary channel to a different subband based at least in part on detecting the radar signal in the radar subband.
